(19) United States
(12) Patent Application Publication
(10) Pub. No.: US 2012/0067999 A1
(43) Pub. Date: Mar. 22, 2012

(54) TAPE REEL AND INFORMATION RECORDING MEDIUM

(75) Inventors: Takateru SATOH, Tokyo (JP); Chotaro KOUZU, Tokyo (JP); Hiroki SUZUKI, Tokyo (JP); Keiji TESHIMA, Tokyo (JP); Shintaro SHINKAWA, Tokyo (JP)

(73) Assignee: TDK CORPORATION, Tokyo (JP)

(21) Appl. No.: 13/235,933

(22) Filed: Sep. 19, 2011

(30) Foreign Application Priority Data
Sep. 22, 2010 (JP) 2010-211600

(51) Int. Cl. B65H 75/14; G11B 5/78; B65H 75/18

(52) U.S. Cl. 242/608.3

(57) ABSTRACT

A tape reel includes a first flange, a cylindrical body, and a second flange formed separately. The first flange, the cylindrical body, and second flanges are joined with inner surfaces of the first and second flanges contacting the cylindrical body. Joining pins are erected on the inner surface of the first flange. The cylindrical body includes an outer wall, bosses with through-holes for the joining pins fixed to the inside of the outer wall, and an inner wall positioned inside and following the outer wall. The second flange has an opening formed in the center and a protrusion at an opening edge protruding toward the center and including through-holes through which the joining pins are inserted. Plural positioning pins that contact an outer surface of the inner wall in a state where the cylindrical body is contacted to position the cylindrical body are formed on the first and/or second flange.

### 1. FIELD OF THE INVENTION

The present invention relates to a tape reel around which a magnetic tape for recording information is wound and to an information recording medium equipped with such tape reel.

### 2. DESCRIPTION OF THE RELATED ART

As one example of this type of tape reel, a tape reel assembly (hereinafter simply “tape reel”) disclosed in Japanese Laid-Open Patent Publication No. 2001-118358 is known. This tape reel is used in a single reel-type information recording medium and includes an upper flange, a lower flange, and a hub ring. The upper flange, the lower flange, and the hub ring are formed separately (manufactured separately), with such parts being joined and assembled in a state where the hub ring has been positioned between the upper flange and the lower flange to construct a tape reel. Also, with such tape reel, by having bosses formed on both flanges engage notches formed in inner circumferential edges at both ends of the hub ring, rotation of the hub ring with respect to the flanges is restricted.

As one example, with a construction where the lower flange and the hub ring are integrally formed, when pressure is applied to the hub ring due to a magnetic tape tightening when the tape is wound on, the hub ring deforms so as to become squeezed (i.e., the diameter falls). In keeping with this, the outer circumferential edge of the lower flange becomes tilted toward the upper flange, and as a result, there is the risk of both flanges approaching one another and of contact between the respective flanges and the sides of the tape. On the other hand, with the tape reel described above, by forming the upper flange, the lower flange, and the hub ring separately, compared to a construction where the lower flange and the hub ring are integrally formed, for example, even if the hub ring deforms so as to become squeezed, such deformation is unlikely to directly cause deformation of the flange. This tape reel is therefore somewhat capable of preventing situations where there is contact between the sides of a magnetic tape and the flanges when the tape is wound on and/or difficulty in winding on a magnetic tape due to the gap between the two flanges narrowing.

### SUMMARY OF THE INVENTION

However, as a result of investigating the conventional tape reel described above, the present inventors discovered the following problem with the conventional tape reel. That is, with the tape reel described above, notches formed in inner circumferential edges at both ends of the hub ring and bosses formed in the respective flanges are caused to engage one another. In the engaged state, the positions where the notches are formed at both ends of the hub ring are positioned outside the bosses. This means that when the hub ring deforms so as to become squeezed due to the magnetic tape being tightened, there is the risk of the parts where the notches are formed applying pressure to the bosses and such pressing forces causing the flanges to deform. Accordingly, with the conventional tape reel, as before there is still the problem of the sides of the tape contacting the flanges when the magnetic tape is wound on and/or the gap between the two flanges narrowing and making it difficult to wind on a magnetic tape.

The present invention was conceived in view of the problem described above and it is a main object of the present invention to provide a tape reel and an information recording medium capable of reliably preventing deformation of the flanges due to tightening of a magnetic tape when the magnetic tape is wound on.

To achieve the stated object, a tape reel according to the present invention comprises a first flange, a cylindrical body, and a second flange that are formed as separate objects, wherein the tape reel is constructed by joining the first flange, the cylindrical body, and the second flange in a state where an inner surface side of the first flange and an inner surface side of the second flange are in contact with the cylindrical body and face one another, the first flange includes joining pins erected on the inner surface of the first flange, the cylindrical body includes an outer circumferential wall, bosses which are fixed to the outer circumferential wall on an inside of the outer circumferential wall and in which through-holes through which the joining pins are inserted are formed, and an inner wall which is positioned inside the outer circumferential wall and disposed so as to follow the outer circumferential wall, the second flange has an opening formed in a central portion thereof and includes a protruding portion that is formed at an edge portion of the opening so as to protrude toward a center of the opening and includes through-holes through which the joining pins are inserted, and on at least one of the first flange and the second flange, a plurality of positioning pins that contact a surface on an outer circumferential wall side of the inner wall in a state where the cylindrical body is contacted by at least one of the first flange and the second flange to position the cylindrical body are formed.

Also, an information recording medium according to the present invention comprises the tape reel described above.

According to the tape reel and the information recording medium, the cylindrical body is constructed so as to include the bosses, in which the through-holes through which the joining pins erected on the first flange are inserted are formed, and the inner wall, the second flange is constructed so as to include the protruding portions including the through-holes through which the joining pins are inserted, and a plurality of the positioning pins that contact the surface on the outer circumferential wall side of the inner wall to position the cylindrical body are formed on the first flange. By doing so, even if the outer circumferential wall has deformed so as to become squeezed due to pressure applied by tightening of a magnetic tape when the magnetic tape is wound on, it is possible to maintain a state where pressure is not applied to the joining pins and the positioning pins. Therefore, according to the tape reel and the information recording medium, since it is possible to reliably prevent deformation of the first flange and the second flange due to pressure being applied to the joining pins and/or the positioning pins, it is possible to reliably prevent contact between the sides of a magnetic tape and the first flange and second flange when the magnetic tape is wound on.

Also, in the tape reel according to the present invention, the edge portion of the second flange may be formed in a cylindrical shape that protrudes toward the first flange and fits inside the outer circumferential wall, the protruding portion may be formed at a front end portion of the cylindrical edge portion, and the cylindrical body is joined to the second flange in a state where an end surface on a second flange side of at least one of the bosses and the inner wall contacts the protruding portion and an end surface on the second flange side of the outer circumferential wall is apart from the inner surface of the second flange.

By using such construction, even if the second flange is pressed onto the cylindrical body when the first flange, the cylindrical body, and the second flange are joined, a pressing force in the direction from the first flange toward the second flange does not act from the outer circumferential wall of the cylindrical body onto the second flange. This means it is possible to sufficiently suppress deformation where the outer circumferential edge of the second flange becomes outwardly opened away from the outer circumferential edge of the first flange. As a result, according to the tape reel and the information recording medium, it is possible to reliably avoid a situation where, due to the outer circumferential edge of the second flange being outwardly opened, a magnetic tape becomes wound on the tape reel in a state where the ends in the width direction of the magnetic tape are not aligned (a state where the tape reel is not properly wound on with the end portions of the magnetic tape in alignment), which can cause creasing of the tape, improper rotation of the tape reel, recording/reproduction errors, and the like.

Also, in the tape reel according to the present invention, a thickened portion that protrudes toward the second flange side and fits inside the outer circumferential wall may be formed on the inner surface of the first flange, and the cylindrical body may be joined to the first flange in a state where an end surface on the first flange side of at least one of the bosses and the inner wall contacts the thickened portion and an end surface on the first flange side of the outer circumferential wall is away from the inner surface of the first flange.

By using such construction, even if the cylindrical body is pressed onto the first flange when the first flange, the cylindrical body, and the second flange are joined, the pressure will act upon the thickened portion that has high rigidity, making it possible to sufficiently suppress deformation where the outer circumferential edge of the first flange becomes outwardly opened away from the outer circumferential edge of the second flange. As a result, according to the tape reel and the information recording medium, it is possible to reliably prevent a situation where creasing of the tape, improper rotation of the tape reel, recording/reproduction errors, and the like occur due to the outer circumferential edge of the first flange becoming outwardly opened.

Also, in the tape reel according to the present invention, the positioning pins may be formed on both the first flange and the second flange.

By using such construction, it is possible to more reliably position the cylindrical body with respect to the first flange and the second flange.

Also, in the tape reel according to the present invention, the bosses and the inner wall may be joined, and the inner wall may be fixed to the outer circumferential wall via the bosses.

By using such construction, it is possible to sufficiently increase the strength of the inner wall.

It should be noted that the disclosure of the present invention relates to a content of Japanese Patent Application 2010-211600 that was filed on 22 Sep. 2010 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is an exploded perspective view of an information recording medium;

FIG. 2 is a perspective view of a tape reel;

FIG. 3 is a plan view of the tape reel;

FIG. 4 is an exploded perspective view of the tape reel in a state where a first flange is at the bottom;

FIG. 5 is an exploded perspective view of the tape reel in a state where a second flange is at the bottom;

FIG. 6 is a plan view of the first flange;

FIG. 7 is a plan view of a cylindrical body;

FIG. 8 is a plan view of the second flange;

FIG. 9 is a plan view of a state where the cylindrical body has been fitted into the first flange;

FIG. 10 is a cross-sectional view along a line A-A in FIG. 3;

FIG. 11 is an enlarged view of a region B in FIG. 10;

FIG. 12 is an enlarged view of a region C in FIG. 10; and

FIG. 13 is a plan view of another second flange.

### DESCRIPTION OF THE PREFERRED EMBODIMENTS

Preferred embodiments of a tape reel and an information recording medium according to the present invention will now be described with reference to the attached drawings.

First, the construction of an information recording medium 1 will be described with reference to the drawings.

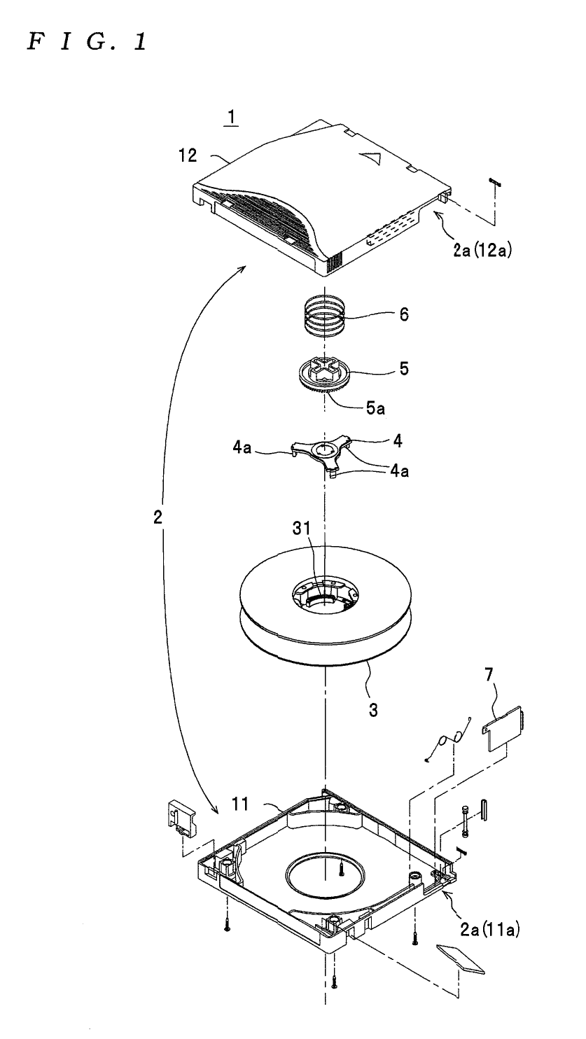

The information recording medium 1 shown in FIG. 1 is a single-reel type information recording medium used in a storage device for backing up recording data that has been recorded in an electronic computer for example, and as shown in the diagram, includes a case main body 2, a tape reel 3, a brake releasing plate 4, a locking member 5, a brake spring 6, and a door member 7. Note that although in reality a magnetic tape is wound around the tape reel 3 of the information recording medium 1, for ease of understanding the construction of the respective parts, the magnetic tape has been omitted from FIG. 1.

As shown in FIG. 1, the case main body 2 includes a lower case 11 and an upper case 12 that are formed in shallow plate-like shapes and are capable of fitting together, with the tape reel 3 being rotatably enclosed in the internal space formed when the two cases 11, 12 are fitted together. Here, cutaway parts 11a, 12a that construct a tape withdrawal opening 2a for pulling the magnetic tape wound around the tape reel 3 out of the case main body 2 are respectively formed in the lower case 11 and the upper case 12.

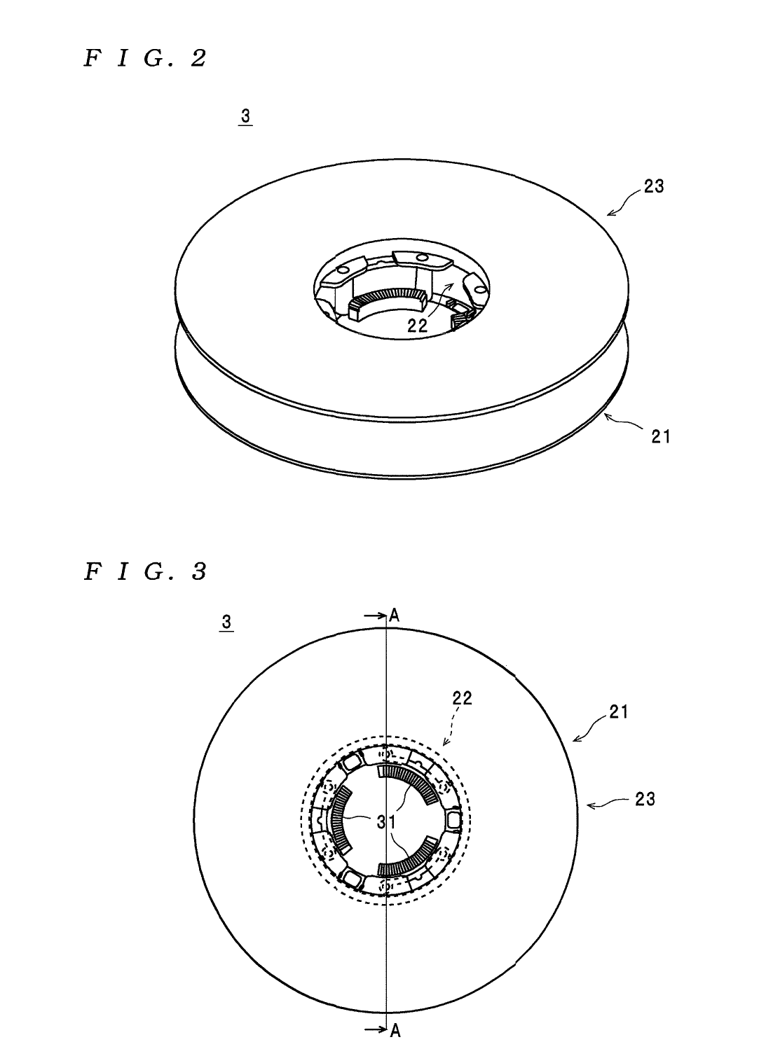

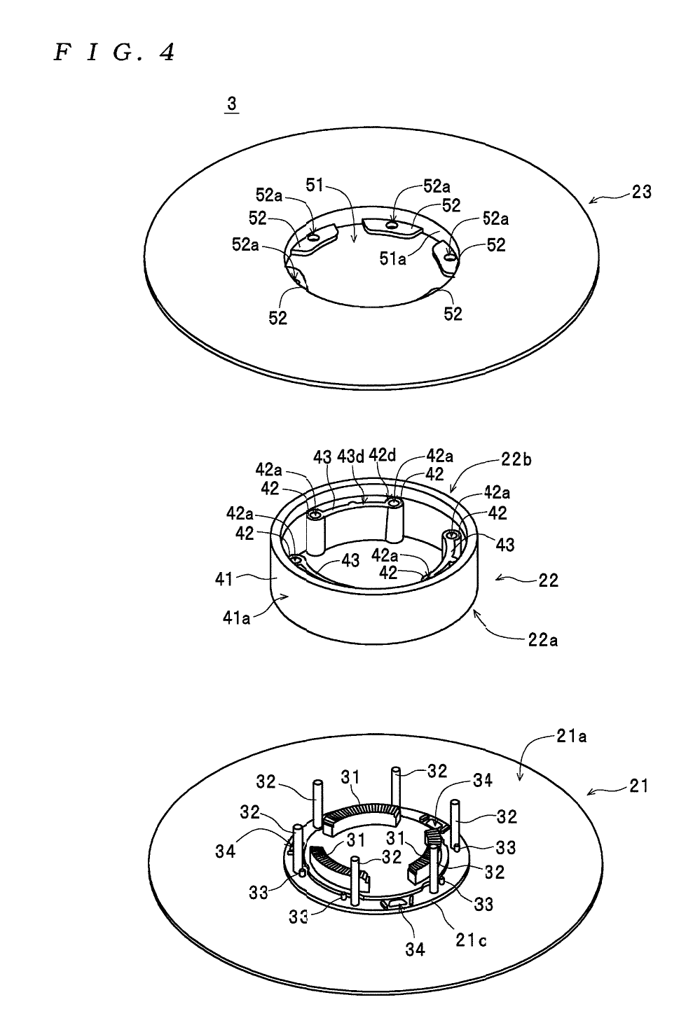

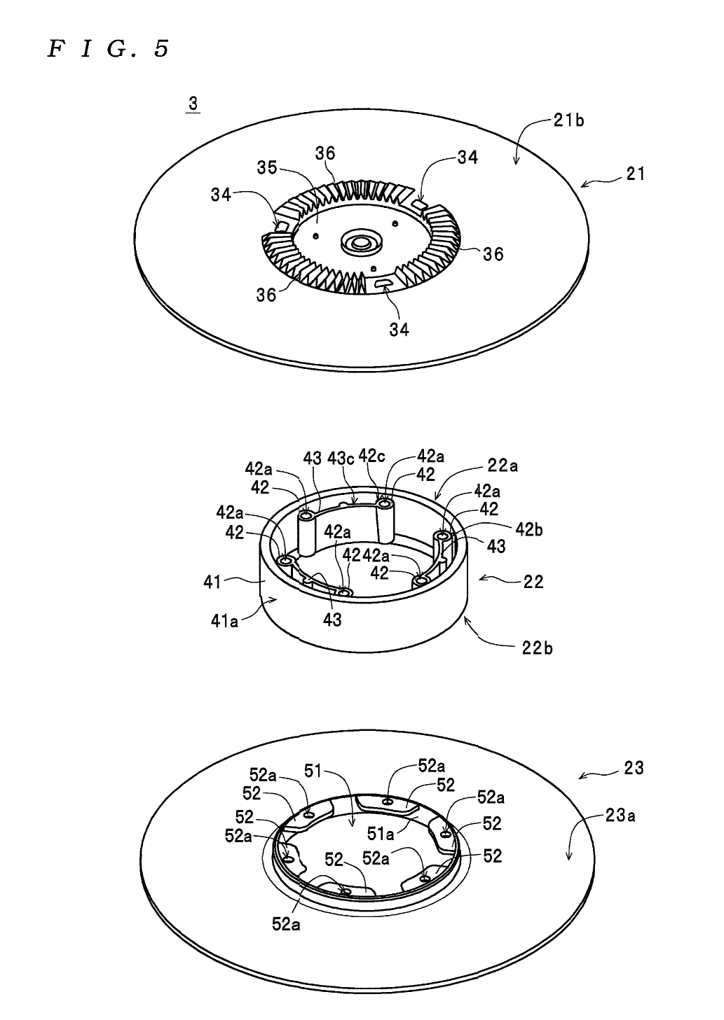

As shown in FIGS. 4 and 5, the tape reel 3 includes a first flange 21, a cylindrical body 22, and a second flange 23 that are separately formed, and is capable of having a magnetic tape wound thereon. As shown in FIGS. 2 to 5 and 10, the tape reel 3 is assembled with an inner surface 21a side of the first flange 21 positioned on an end portion 22a side of the cylindrical body 22, an inner surface 23a side of the second flange 23 positioned on an end portion 22b side of the cylindrical body 22, the respective inner surface 21a, 23a sides in contact with the cylindrical body 22 in a facing state, and the first flange 21, the cylindrical body 22, and the second flange 23 joined to one another.

As shown in FIGS. 4 to 6, the first flange 21 is constructed in a disc shape. Also, a thickened portion 21c, which protrudes toward the second flange 23 in the facing state described above and fits inside an outer circumferential wall 41 of the cylindrical body 22, is formed in a central portion of the inner surface 21a (the upper surface in FIG. 4) of the first flange 21. Here, as shown in FIG. 11, the thickened portion 21c is formed so that a protruding length L1 from the inner surface 21a of the first flange 21 (i.e., the thickness of the thickened portion 21c) is greater than a step height L2 of the cylindrical body 22, described later. Also, three toothed portions 31, which are arc-shaped when viewed from above and capable of meshing the locking member 5 that is energized by the brake spring 6 (both shown in FIG. 1), are formed on the thickened portion 21c of the first flange 21. Three through-holes 34 for attaching the brake releasing plate 4 so as to be capable of moving up and down are also formed in the first flange 21.

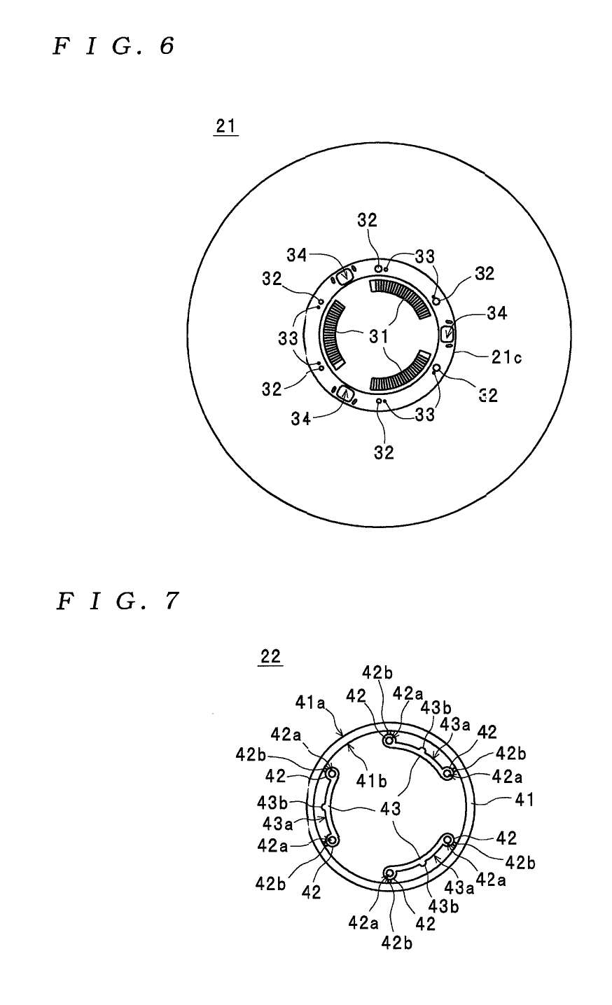

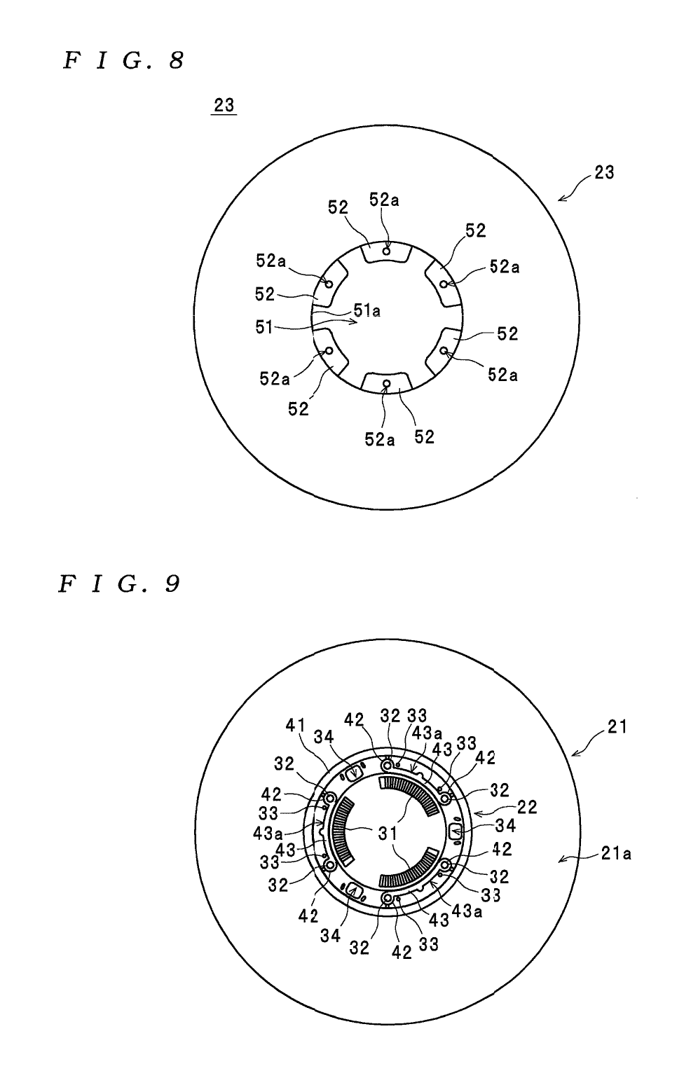

As shown in FIGS. 4 and 6, a plurality (for example, six) of joining pins 32 for joining the first flange 21, the cylindrical body 22, and the second flange 23 and restricting rotation of the second flange 23 with respect to the first flange 21 and the cylindrical body 22 are erected on the thickened portion 21c of the first flange 21. In this case, the positions where the joining pins 32 are erected are set so that as shown in FIG. 9, in a state where the inner surface 21a side of the first flange 21 contacts the cylindrical body 22, the joining pins 32 are positioned to the inside (i.e., toward the center of the cylindrical body 22) of the outer circumferential wall 41 of the cylindrical body 22 and pass through through-holes 42a of bosses 42 (see FIGS. 4 and 7) formed on the cylindrical body 22. The length of the joining pins 32 is set longer than the total of the length of the bosses 42 and the thickness of protruding portions 52 (see FIG. 8) of the second flange 23. From the viewpoints of achieving sufficient strength and preventing sink marks during molding, a diameter (outer diameter) D1 of the joining pins 32 (see FIG. 11) should preferably be in a range of 1.2 mm to 2.0 mm, inclusive. As one example, with the tape reel 3, the joining pins 32 are formed so that the diameter D1 thereof is 1.6 mm.

Also, as shown in FIG. 9, a plurality (for example, six) of positioning pins 33 for contacting outer surfaces 43a of inner walls 43 of the cylindrical body 22 to position the cylindrical body 22 in a state where the inner surface 21a side contacts the cylindrical body 22 are formed on the inner surface 21a of the first flange 21. Here, to facilitate attachment of the cylindrical body 22 to the first flange 21 when assembling the tape reel 3, the positioning pins 33 are formed so that the diameter of the front end portions thereof is smaller than the diameter of the base end portions (i.e., the positioning pins 33 are tapered).

In addition, as shown in FIG. 5, a metal plate 35 is attached to an outer surface 21b (the upper surface in FIG. 5) of the first flange 21 to enable the drive shaft of a drive apparatus, not shown, to magnetically attract the tape reel 3. A ring-shaped toothed portion 36 that is capable of meshing a toothed portion of the drive shaft of the drive apparatus is formed on the outer surface 21b of the first flange 21 so as to surround the metal plate 35.

As shown in FIGS. 4, 5, and 7, the cylindrical body 22 is formed in a cylindrical shape and is constructed so that a magnetic tape can be wound around an outer surface 41a side of the outer circumferential wall 41. A plurality of (for example, six) bosses 42, in which through-holes 42a through which the joining pins 32 of the first flange 21 can pass through are formed, are also disposed on the inside (i.e., toward the center of the cylindrical body 22) of the outer circumferential wall 41. The respective bosses 42 are disposed at equal intervals around an inner surface 41b of the outer circumferential wall 41 and are fixed to the outer circumferential wall 41 via ribs 42b (see FIGS. 5, 7). In this case, as shown in FIG. 11, the through-holes 42a of the bosses 42 are formed so that a diameter (inner diameter) D2 thereof is larger than the diameter D1 of the joining pins 32 so as to produce gaps (clearances) between the inner surfaces of the through-holes 42a and the outer circumferential surfaces of the joining pins 32 when the joining pins 32 have been inserted. More specifically, the through-holes 42a are formed so that the diameter D2 thereof is around 0.2 mm to 1.0 mm larger than the diameter D1 of the joining pins 32 so that the gaps described above are in a range of 0.1 mm to 0.5 mm, inclusive. As one example, in the tape reel 3, the through-holes 42a are formed so that the diameter D2 thereof is 2.2 mm.

Also, as shown in FIGS. 4, 5, and 7, a plurality of (for example, three) inner walls 43 that are arc-shaped when viewed from above are disposed further inside than the outer circumferential wall 41 so as to follow the outer circumferential wall 41 and face the inner surface 41b of the outer circumferential wall 41 at a distance from the inner surface 41b. Both end portions of each of the inner walls 43 are connected to two of the bosses 42. That is, each inner wall 43 is fixed to the outer circumferential wall 41 via two bosses 42. A reinforcing rib 43b in the form of a half cylinder is also formed in a central portion of each inner wall 43. Here, by forming the reinforcing ribs 43b, it is possible to increase the strength of the inner walls 43 and, by having ejection pins contact the end surfaces of the reinforcing ribs 43b when removing the cylindrical body 22 from a mold during injection molding of the cylindrical body 22, it is also possible to reliably remove the cylindrical body 22 from the mold without damaging the inner walls 43.

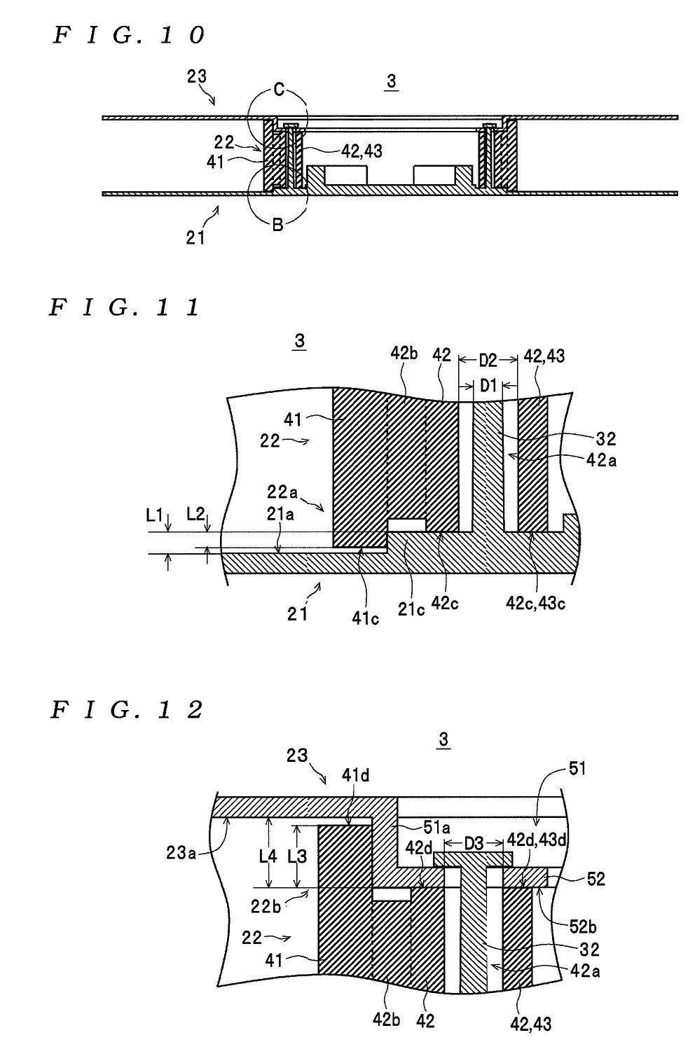

Also, as shown in FIG. 5, on the cylindrical body 22, end surfaces 42c on the end portion 22a side of the bosses 42 are formed so as to be flush with the end surfaces 43c on the end portion 22a side of the inner walls 43. Also, as shown in FIG. 4, end surfaces 42d on the end portion 22b side of the bosses 42 are formed so as to be flush with end surfaces 43d on the end portion 22b side of the inner walls 43. That is, the bosses 42 and the inner walls 43 are formed so that the heights thereof (that is, the lengths along the thickness direction of the tape reel 3) are the same. In addition, as shown in FIG. 10, the height of the outer circumferential wall 41 is formed on the cylindrical body 22 so as to be higher than the heights of the bosses 42 and the inner walls 43. In this case, as shown in FIG. 11, the cylindrical body 22 is formed so that the step height L2 between the end surface 41c of the outer circumferential wall 41 on the end portion 22a side and the end surfaces 42c of the bosses 42 and the end surfaces 43c of the inner walls 43 on the end portion 22a side (i.e., the length from the end surface 41c to the end surfaces 42c, 43c) is shorter than the protruding length L1 of the thickened portion 21c of the first flange 21 described above. This means that as shown in FIG. 11, the cylindrical body 22 is joined to the first flange 21 in a state where the end surfaces 42c of the bosses 42 and the end surfaces 43c of the inner walls 43 positioned on the first flange 21 side contact the surface of the thickened portion 21c and the end surface 41c of the outer circumferential wall 41 positioned on the first flange 21 side and the inner surface 21a of the first flange 21 are apart.

Also, as shown in FIG. 12, the cylindrical body 22 is formed so that the step height L3 between the end surface 41d of the outer circumferential wall 41 on the end portion 22b side and the end surfaces 42d of the bosses 42 and the end surfaces 43d of the inner walls 43 on the end portion 22b side (that is, the length from the end surface 41d to the end surfaces 42d, 43d) is shorter than the length L4 from the inner surface 23a of the second flange 23 to inner surfaces 52b of the protruding portions 52, described later.

As shown in FIGS. 4, 5, and 8, the second flange 23 is constructed in a disc shape. The second flange 23 also has a circular opening 51 formed in a center thereof. An edge portion 51a of the opening 51 protrudes downward (i.e., in a direction toward the first flange side) and is formed in a cylindrical shape so as to fit inside the outer circumferential wall 41 of the cylindrical body 22 in the assembled state. In addition, on a front end portion (lower end portion) of the edge portion 51a, a plurality of (for example, six) protruding portions 52 that protrude toward the center of the opening 51 are formed at equal intervals apart around the edge portion 51a. Through-holes 52a, through which the joining pins 32 formed on the first flange 21 are capable of being inserted, are also formed in the protruding portions 52. In this case, as shown in FIG. 12, in the same way as the through-holes 42a of the bosses 42 on the cylindrical body 22 described above, the through-holes 52a of the protruding portions 52 are formed so that a diameter (inner diameter) D3 thereof is around 0.2 mm to 1.0 mm larger than the diameter D1 of the joining pins 32 to produce gaps in a range of 0.1 mm to 0.5 mm, inclusive, between the inner surfaces of the through-holes 52a and the outer circumferential surfaces of the joining pins 32. As one example, in the tape reel 3, the through-holes 52a are formed so that the diameter D3 thereof is 2.2 mm.

Also, as shown in FIG. 12, the second flange 23 is formed so that the length L4 from the inner surface 23a of the second flange 23 to the inner surfaces 52b of the protruding portions 52 is longer than the step height L3 between the end surface 41d of the outer circumferential wall 41 and the end surfaces 42d of the bosses 42 and the end surfaces 43d of the inner walls 43 on the cylindrical body 22 described above. This means that as shown in FIG. 12, the cylindrical body 22 is joined to the second flange 23 in a state where the end surfaces 42d of the bosses 42 and the end surfaces 43d of the inner walls 43 positioned on the second flange 23 side contact the inner surfaces 52b of the protruding portions 52 and the end surface 41d of the outer circumferential wall 41 positioned on the second flange 23 side and the inner surface 23a of the second flange 23 are apart.

As shown in FIG. 1, the brake releasing plate 4 is constructed with three leg portions 4a that are capable of being inserted through the through-holes 34 formed in the first flange 21 of the tape reel 3 erected on the rear surface thereof. By passing the leg portions 4a through the respective through-holes 34, the brake releasing plate 4 is disposed inside the cylindrical body 22 of the tape reel 3 so as to be incapable of rotation but capable of moving up and down.

As shown in FIG. 1, the locking member 5 has toothed portions 5a, which are capable of meshing with the toothed portions 31 of the tape reel 3, formed on the bottom surface thereof. Here, the locking member 5 is energized by the brake spring 6 and the toothed portions 5a mesh with the toothed portions 31 of the tape reel 3 to restrict rotation of the tape reel 3.

The brake spring 6 is constructed of a coil spring, is disposed between the upper case 12 and the locking member 5, and energizes the locking member 5 toward the first flange 21 side of the tape reel 3. As shown in FIG. 1, the door member 7 is formed in the shape of a thin plate that is capable of closing the tape withdrawal opening 2a and is slidably housed in guide grooves respectively formed in a side wall of the lower case 11 and a side wall of the upper case 12.

Next, one example method of assembling the tape reel 3 will be described. First, as shown in FIG. 4, the first flange 21 is disposed on an assembly platform in a state where the inner surface 21a faces upward. After this, in a state where the end portion 22a of the cylindrical body 22 faces downward and the respective joining pins 32 of the first flange 21 are inserted through the respective through-holes 42a of the bosses 42 of the cylindrical body 22, the cylindrical body 22 is pressed downward toward the first flange 21 to bring the cylindrical body 22 into contact with the inner surface 21a side of the first flange 21. When doing so, as shown in FIG. 9, the positioning pins 33 contact the outer surfaces 43a of the inner walls 43 of the cylindrical body 22 to position the cylindrical body 22. Also, as shown in FIG. 11, since the step height L2 between the end surface 41c of the cylindrical body 22 and the end surfaces 42c, 43c is shorter than the protruding length L1 of the thickened portion 21c of the first flange 21, in such state the end surfaces 42c, 43c contact the surface of the thickened portion 21c and the end surface 41c and the inner surface 21a of the first flange 21 are apart. Also, since the length of the respective bosses 42 is slightly shorter than the joining pins 32, in this state the front end portions of the joining pins 32 protrude from the bosses 42.

After this, while inserting the front end portions of the respective joining pins 32 that protrude from the bosses 42 through the through-holes 52a of the protruding portions 52 of the second flange 23, the second flange 23 is pressed down toward the cylindrical body 22 to bring the inner surface (the lower surface in FIG. 4) side of the second flange 23 into contact with the cylindrical body 22. Here, as shown in FIG. 12, since the step height L3 between the end surface 41d of the cylindrical body 22 and the end surfaces 42d, 43d is shorter than the length L4 from the inner surface 23a of the second flange 23 to the inner surfaces 52b of the protruding portions 52, in this state the end surfaces 42d, 43d contact the inner surfaces 52b of the protruding portions 52 and the end surface 41d and the inner surface 23a of the second flange 23 are apart. Also, since the length of the joining pins 32 is longer than the total of the length of the bosses 42 and the thicknesses of the protruding portions 52 of the second flange 23, in this state, the front end portions of the joining pins 32 protrude from the protruding portions 52. Next, by melting the front end portions of the joining pins 32 protruding from the protruding portions 52 using an ultrasonic welding apparatus, the second flange 23 is fastened (crimped) to the cylindrical body 22. By doing so, the first flange 21, the cylindrical body 22, and the second flange 23 are joined via the joining pins 32 to assemble the tape reel 3.

Here, as described above, during assembly of the tape reel 3, the end surfaces 42d, 43d of the cylindrical body 22 contact the inner surfaces 52b of the protruding portions 52 of the second flange 23 and the end surface 41d of the cylindrical body 22 and the inner surface 23a of the second flange 23 are apart. This means that when the first flange 21, the cylindrical body 22, and the second flange 23 are joined (crimped), even if the second flange 23 is pressed onto the cylindrical body 22, the pressure that acts from the first flange 21 toward the second flange 23 will not act from the outer circumferential wall 41 of the cylindrical body 22 onto the second flange 23, which makes it possible to sufficiently suppress deformation where the outer circumferential edge of the second flange 23 becomes outwardly opened away from the outer circumferential edge of the first flange 21. Also, as described above, during assembly of the tape reel 3, the end surfaces 42c, 43c of the cylindrical body 22 contact the thickened portion 21c of the first flange 21 and the end surface 41c of the cylindrical body 22 is apart from the inner surface 21a of the first flange 21. This means that when the cylindrical body 22 and the second flange 23 are joined (crimped), even if the cylindrical body 22 is pressed onto the first flange 21, since such pressure will act upon the thickened portion 21c that has high rigidity, it is possible to sufficiently suppress deformation that causes the outer circumferential edge of the first flange 21 to become outwardly opened away from the outer circumferential edge of the second flange 23. In addition, with the tape reel 3, the bosses 42 and the inner walls 43 are formed with the same heights, the end surfaces 42c and the end surfaces 43c are flush, and the end surfaces 42d and the end surfaces 43d are also flush. This means that the area of contact between the bosses 42 and inner walls 43 of the cylindrical body 22 and the protruding portions 52 of the second flange 23 and the area of contact between the bosses 42 and inner walls 43 of the cylindrical body 22 and the thickened portion 21c of the first flange 21 are large. As a result, the pressure applied when the first flange 21, the cylindrical body 22, and the second flange 23 are joined is dispersed and it is possible to sufficiently suppress deformation of certain parts due to the pressure being concentrated.

Next, the operation of the information recording medium 1 during recording and reproduction will be described with reference to the drawings.

When the information recording medium 1 has been loaded in a drive apparatus, not shown, the drive apparatus slides the door member 7 to open the tape withdrawal opening 2a and pulls out the magnetic tape. Next, a tape reel on the drive apparatus side winds on the magnetic tape while a recording/reproduction unit of the drive apparatus carries out the recording of data on the magnetic tape or the reading of recorded data from the magnetic tape. After this, when the recording and/or reading of data has been completed, the drive apparatus rotates the tape reel 3 to start winding on the magnetic tape (i.e., rewinding the magnetic tape back onto the information recording medium 1). When doing so, to prevent slackening, as one example, the drive apparatus controls the rotation of the tape reel on the drive apparatus side to apply a constant tension to the magnetic tape. By doing so, the magnetic tape is wound onto the tape reel 3. At this time, since tension is applied to the magnetic tape, a certain degree of force toward the center is applied to the outer circumferential wall 41 of the cylindrical body 22 due to the tightening of the magnetic tape.

In this case, with the tape reel 3, since a gap of around 0.1 mm is produced between the joining pins 32 of the first flange 21 and the inner circumferential walls of the through-holes 42a of the bosses 42 of the cylindrical body 22, even if there is deformation that squeezes the outer circumferential wall 41 due to the pressure applied by the tightening of the magnetic tape, the joining pins 32 will remain in a state where pressure is not applied thereto from the outer circumferential wall 41 due to such squeezing. Also with the tape reel 3, the positioning pins 33 contact the outer surfaces 43a of the inner walls 43 and the positioning pins 33 do not contact the outer circumferential wall 41. This means that even if a large force is applied to the outer circumferential wall 41 due to the tightening of the magnetic tape, resulting in the outer circumferential wall 41 deforming so as to become squeezed, the positioning pins 33 that are not in contact with the outer circumferential wall 41 will remain in a state where pressure is not applied from the outer circumferential wall 41 due to the squeezing. Also, even if the inner walls 43 that are fixed via the bosses 42 to the outer circumferential wall 41 deform so as to move toward the inside due to the squeezing of the outer circumferential wall 41, the positioning pins 33 that contact the outer surfaces 43a of the inner walls 43 maintain a state where pressure is not applied to the inner walls 43 due to the squeezing. Accordingly, with the tape reel 3, since it is possible to reliably prevent deformation of the first flange 21 and the second flange 23 due to pressure applied to the joining pins 32 and/or the positioning pins 33, it is possible to reliably prevent contact between the sides of a magnetic tape and the first flange 21 and the second flange 23 in a state where the magnetic tape has been wound on.

In this way, according to the tape reel 3 and the information recording medium 1, the cylindrical body 22 is constructed so as to include the bosses 42, in which the through-holes 42a through which the joining pins 32 erected on the first flange 21 are inserted are formed, and the inner walls 43, the second flange 23 is constructed so as to include the protruding portions 52 including the through-holes 52a through which the joining pins 32 are inserted, and a plurality of the positioning pins 33 that contact the outer surfaces 43a of the inner walls 43 to position the cylindrical body 22 are formed on the first flange 21. By doing so, even if the outer circumferential wall 41 has deformed so as to become squeezed due to pressure applied by tightening of a magnetic tape when the magnetic tape is wound on, it is possible to maintain a state where pressure is not applied to the joining pins 32 and the positioning pins 33. Therefore, according to the tape reel 3 and the information recording medium 1, since it is possible to reliably prevent deformation of the first flange 21 and the second flange 23 due to pressure being applied to the joining pins 32 and/or the positioning pins 33, it is possible to reliably prevent contact between the sides of a magnetic tape and the first flange 21 and second flange 23 when the magnetic tape is wound on.

Also, according to the tape reel 3 and the information recording medium 1, the edge portion 51a of the second flange 23 is formed in a cylindrical shape so as to protrude toward the first flange 21 and fit inside the outer circumferential wall 41 of the cylindrical body 22, the protruding portions 52 are formed on the front end portion of the edge portion 51a, and the cylindrical body 22 and the second flange 23 are joined in a state where the end surfaces 42d, 43d on the second flange 23 side of the bosses 42 and the inner walls 43 and the protruding portions 52 are in contact and the end surface 41d on the second flange 23 side of the outer circumferential wall 41 and the inner surface 23a of the second flange 23 are apart. By doing so, even if the second flange 23 is pressed onto the cylindrical body 22 when the first flange 21, the cylindrical body 22, and the second flange 23 are joined, a pressing force in the direction from the first flange 21 toward the second flange 23 does not act from the outer circumferential wall 41 of the cylindrical body 22 onto the second flange 23. This means it is possible to sufficiently suppress deformation where the outer circumferential edge of the second flange 23 becomes outwardly opened away from the outer circumferential edge of the first flange 21. As a result, according to the tape reel 3 and the information recording medium 1, it is possible to reliably avoid a situation where, due to the outer circumferential edge of the second flange 23 being outwardly opened, a magnetic tape becomes wound on the tape reel 3 in a state where the ends in the width direction of the magnetic tape are not aligned (a state where the tape reel 3 is not properly wound on with the end portions of the magnetic tape in alignment), which can cause creasing of the tape, improper rotation of the tape reel, recording/reproduction errors, and the like.

Also, according to the tape reel 3 and the information recording medium 1, a construction is used where the thickened portion 21c that protrudes toward the second flange 23 and fits inside the outer circumferential wall 41 of the cylindrical body 22 is formed on the inner surface 21a of the first flange 21 and the cylindrical body 22 and the first flange 21 are joined in a state where the end surfaces 42c, 43c on the first flange 21 side of the bosses 42 and the inner walls 43 contact the thickened portion 21c and the end surface 41c on the first flange 21 side of the outer circumferential wall 41 and the inner surface 21a of the first flange 21 are apart. By doing so, even if the cylindrical body 22 is pressed onto the first flange 21 when the first flange 21, the cylindrical body 22, and the second flange 23 are joined, the pressure will act upon the thickened portion 21c that has high rigidity, making it possible to sufficiently suppress deformation where the outer circumferential edge of the first flange 21 becomes outwardly opened away from the outer circumferential edge of the second flange 23. As a result, according to the tape reel 3 and the information recording medium 1, it is possible to reliably prevent a situation where creasing of the tape, improper rotation of the tape reel, recording/reproduction errors, and the like occur due to the outer circumferential edge of the first flange 21 becoming outwardly opened.

Also according to the tape reel 3 and the information recording medium 1, by fixing each inner wall 43 to the outer circumferential wall 41 via two bosses 42, it is possible to sufficiently increase the strength of the inner walls 43.

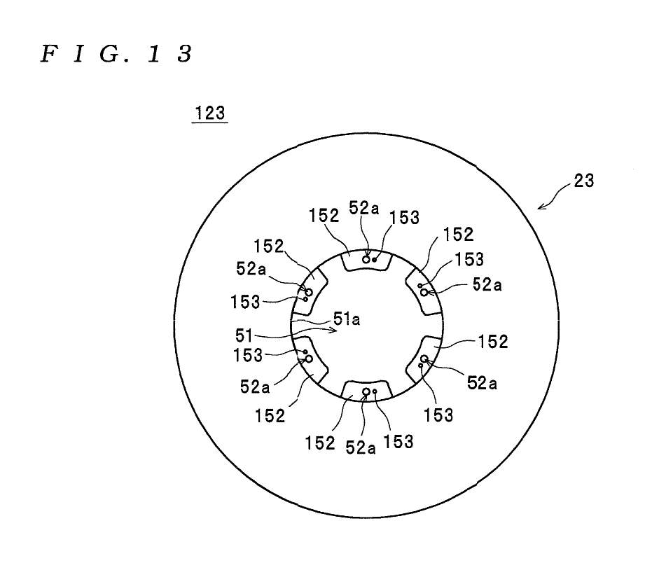

Note that the tape reel is not limited to the construction described above and can be modified as appropriate. For example, in place of the second flange 23 described above, it is possible to apply the present invention to a tape reel including the second flange 123 shown in FIG. 13. Note that in the following description, component elements that are the same as the second flange 23 described above have been assigned the same reference numerals and duplicated description thereof is omitted. As shown in FIG. 13, on the second flange 123, a plurality of (for example, six) protruding portions 152 including through-holes 52a are formed on the edge portion 51a of the opening 51. Also, a positioning pin 153 that contacts the outer surface 43a of an inner wall 43 of the cylindrical body 22 to position the cylindrical body 22 in a state where the second flange 123 contacts the cylindrical body 22 is individually formed on the inner surface (i.e., the nearer surface in the plane of the paper for FIG. 13, a surface positioned on the cylindrical body 22 side when the tape reel has been assembled) of each protruding portion 152 (making a total of six positioning pins 153). That is, with this tape reel, positioning pins are formed on both the first flange 21 and the second flange 23. According to this construction, it is possible to more reliably position the cylindrical body 22 with respect to the first flange 21 and the second flange 23.

It is also possible to use a construction where the positioning pins 33 of the first flange 21 described above are omitted, that is, a construction where the positioning pins 153 are provided only on the second flange 123. Also, with the construction described above, although both the end surfaces 42d on the second flange 23 side of the bosses 42 and the end surfaces 43d on the second flange 23 side of the inner wall 43 contact the protruding portions 52 when the first flange 21, the cylindrical body 22, and the second flange 23 are joined, it is also possible to use a construction where only one of the end surfaces 42d and the end surfaces 43d contact the protruding portions 52. Also, with the construction described above, although both the end surfaces 42c on the first flange 21 side of the bosses 42 and the end surfaces 43c on the first flange 21 side of the inner wall 43 contact the thickened portion 21c when the first flange 21, the cylindrical body 22, and the second flange 23 are joined, it is also possible to use a construction where only one of the end surfaces 42c and the end surfaces 43c contact the thickened portion 21c. Also, not all of the positioning pins 33 need to contact the outer surfaces 43a of the inner walls 43, and so long as it is possible to position the cylindrical body 22 when joining the first flange 21, the cylindrical body 22, and the second flange 23, such positioning pins 33 may be separated from the outer surface 43a after joining.

Also, although an example that is adapted to a single reel-type information recording medium 1 has been described above, it is also possible to apply the present invention to a two reel-type information recording medium such as a video tape.

What is claimed is:

1. A tape reel comprising a first flange, a cylindrical body, and a second flange that are formed as separate objects,
wherein the tape reel is constructed by joining the first flange, the cylindrical body, and the second flange in a state where an inner surface side of the first flange and an inner surface side of the second flange are in contact with the cylindrical body and face one another,
the first flange includes joining pins erected on the inner surface of the first flange,
the cylindrical body includes an outer circumferential wall, bosses which are fixed to the outer circumferential wall on an inside of the outer circumferential wall and in which through-holes through which the joining pins are inserted are formed, and an inner wall which is positioned inside the outer circumferential wall and disposed so as to follow the outer circumferential wall,
the second flange has an opening formed in a central portion thereof and includes a protruding portion that is formed at an edge portion of the opening so as to protrude toward a center of the opening and includes through-holes through which the joining pins are inserted, and
on at least one of the first flange and the second flange, a plurality of positioning pins that contact a surface on an outer circumferential wall side of the inner wall in a state where the cylindrical body is contacted by at least one of the first flange and the second flange to position the cylindrical body are formed.

2. The tape reel according to claim 1,
wherein the edge portion of the second flange is formed in a cylindrical shape that protrudes toward the first flange and fits inside the outer circumferential wall,
the protruding portion is formed at a front end portion of the cylindrical edge portion, and
the cylindrical body is joined to the second flange in a state where an end surface on a second flange side of at least one of the bosses and the inner wall contacts the protruding portion and an end surface on the second flange side of the outer circumferential wall is apart from the inner surface of the second flange.

3. The tape reel according to claim 1,
wherein a thickened portion that protrudes toward the second flange side and fits inside the outer circumferential wall is formed on the inner surface of the first flange, and
the cylindrical body is joined to the first flange in a state where an end surface on the first flange side of at least one of the bosses and the inner wall contacts the thickened portion and an end surface on the first flange side of the outer circumferential wall is away from the inner surface of the first flange.

4. The tape reel according to claim 1,
wherein the positioning pins are formed on both the first flange and the second flange.

5. The tape reel according to claim 1,
wherein the bosses and the inner wall are joined, and
the inner wall is fixed to the outer circumferential wall via the bosses.

6. An information recording medium comprising the tape reel according to claim 1.
